(19) United States
(12) Patent Application Publication
(10) Pub. No.: US 2023/0369646 A1
(43) Pub. Date: Nov. 16, 2023

(54) OXYGEN AND METAL HALIDE AND/OR HALOGEN ENHANCED METAL-SULFUR BATTERY CATHODES

(71) Applicant: International Business Machines Corporation, Armonk, NY (US)

(72) Inventors: Maxwell Giammona, Fremont, CA (US); Young-hye Na, San Jose, CA (US); Jangwoo Kim, San Jose, CA (US)

(21) Appl. No.: 17/741,669

(22) Filed: May 11, 2022

(51) Int. Cl. H01M 10/0567; H01M 10/0525; H01M 4/134; H01M 4/136; H01M 4/62

(52) U.S. Cl. CPC H01M 10/0567; H01M 10/0525; H01M 4/134; H01M 4/136; H01M 4/625; H01M 2300/0025; H01M 2004/027

(57) ABSTRACT

An enhanced metal-sulfur battery that is exposed to an oxidizing gas prior to and/or during battery operation overcomes the redox shuttle inherent in traditional metal-sulfur batteries. The enhanced metal-sulfur battery has either a sulfur cathode incorporated into an electrically conductive material or a hybrid metal halide-sulfur cathode incorporated into an electrically conductive material. In contrast to traditional metal-sulfur batteries, which have high theoretical capacity, but very low stability, the enhanced metal-sulfur battery shows both high capacity and high stability.

### TECHNICAL FIELD

The present invention relates generally to rechargeable batteries, and more specifically to a rechargeable metal-sulfur battery with cathodes that are enhanced with an oxidizing gas and a metal halide and/or diatomic halogen.

### BACKGROUND OF THE INVENTION

Rechargeable batteries are high in demand for a wide range of applications from small batteries for industrial and medical devices to larger batteries for electric vehicles and grid energy storage systems. Despite the progress that has been made on improving batteries over the past several decades, battery chemistry performance remains insufficient to satisfy the commercial standards expected in the marketplace.

The two main types of rechargeable batteries currently used in the marketplace are: (1) batteries that operate via electrochemical intercalation/de-intercalation behavior of charge-carrying ions, and (2) batteries that operate via chemical conversion of active electrode/electrolyte materials. The most well-known and widely used rechargeable batteries are lithium-ion (Li-ion) batteries, which are intercalation-type batteries. With Li-ion batteries, lithium ions move back and forth within a pond of electrolyte between an anode and a cathode where at least one of the anode or the cathode is an intercalated lithium compound that provides the source of the lithium ions. Despite the ubiquity of Li-ion batteries, these batteries maintain shortcomings, such as cost and stability. One conversion-type battery that has been researched, but is yet to reach the marketplace is a metal-sulfur battery that relies on an alkali or alkali earth metal anode and a sulfur cathode. The sulfur cathode has received a great deal of attention due to its theoretical specific capacity of ˜1700 mAh/g, which is very high when compared to the ˜300 mAh/g specific capacity for a typical NMC (Nickle-Manganese-Cobalt Oxide) Li-ion battery. Metal-sulfur batteries have their own shortcomings, including electron shuttling reactions that reduce the cycling efficiency of the battery and very fast cycle-to-cycle capacity losses.

### SUMMARY OF THE INVENTION

In one aspect, the present invention relates to a battery, comprising: an anode; a cathode comprising sulfur, wherein the cathode is incorporated into an electrically conductive material; and an electrolyte in contact with the anode and the cathode, the electrolyte comprising (i) a solvent with at least one organic liquid compound and (ii) at least one ionic salt dissolved in the solvent, wherein an oxidizing gas is dissolved in the solvent prior to and/or during battery operation.

In another aspect, the present invention relates to a battery comprising: an anode; a cathode comprising sulfur, wherein the cathode is incorporated into an electrically conductive material; an oxidizing gas comprising molecular oxygen; and an electrolyte comprising a solvent and at least one ionic salt, wherein the electrolyte is in contact with the anode, the cathode, and the oxidizing gas.

In a further aspect, the present invention relates to a battery, comprising: an anode comprising a metal selected from the group consisting of L, Mg, Zn, Al, Na, and combinations thereof; a cathode comprising iodine and sulfur, wherein the cathode is incorporated into a carbon-based material; an oxidizing gas comprising molecular oxygen, wherein the molecular oxygen has a volume percentage that is 20-100% of the total volume of the oxidizing gas and any additional inert gas or gases present in the oxidizing gas; and an electrolyte comprising a solvent and at least one ionic salt, wherein the electrolyte is in contact with the anode, the cathode, and the oxidizing gas.

Additional aspects and/or embodiments of the invention will be provided, without limitation, in the detailed description of the invention that is set forth below.

### BRIEF DESCRIPTION OF THE DRAWINGS

FIG. 1 is a graph showing the electrochemistry profile of the first cycle of battery operation of a hybrid lithium-iodide-sulfur (LiI—S) battery enhanced by pre-charging with O₂ prior to cycling (Example 2).

FIGS. 2A and 2B are graphs showing the charge/discharge curves of the first cycle of battery operation (FIG. 2A) and the cycling performance (FIG. 2B) for a lithium-sulfur (Li—S) battery cycled under argon after exposure to O₂ prior to cycling (Example 3).

FIGS. 3A and 3B are graphs showing the first charge/discharge curves of battery operation (FIG. 3A) and cycling performance (FIG. 3B) for an Li—S battery cycled under argon with no exposure to an oxidizing gas (Comparative Example 1).

FIG. 4 is a graph showing the first charge/discharge curves of battery operation and cycling performance for an Li—S battery cycled under argon with no exposure to an oxidizing gas (Comparative Example 1) in comparison to a similar cell exposed to O₂ gas prior to cycling (Example 3).

FIGS. 5A and 5B are graphs showing the first charge/discharge curves of battery operation (FIG. 5A) and cycling performance (FIG. 5B) for an Li—S battery cycled under clean, dry air (Example 4).

FIGS. 6A and 6B are graphs showing the first charge/discharge curves of battery operation (FIG. 6A) and cycling performance (FIG. 6B) for a hybrid LiI—S battery cycled under argon after pre-charging with O₂ prior to cycling (Example 5).

### DETAILED DESCRIPTION OF THE INVENTION

Set forth below is a description of what are currently believed to be preferred aspects and/or embodiments of the claimed invention. Any alternates or modifications in function, purpose, or structure are intended to be covered by the appended claims. As used in this specification and the appended claims, the singular forms “a,” “an,” and “the” include plural referents unless the context clearly dictates otherwise. The terms “comprise,” “comprised,” “comprises,” and/or “comprising,” as used in the specification and appended claims, specify the presence of the expressly recited components, elements, features, and/or steps, but do not preclude the presence or addition of one or more other components, elements, features, and/or steps.

As used herein, the term “conversion-type” refers to a rechargeable battery that converts chemical energy contained within its active materials directly into electrical energy by means of an electrochemical reduction-oxidation (redox) reaction. As is known to those of skill in the art, a redox reaction is a reaction that transfers electrons between (i) a reducing agent that undergoes oxidation through the loss of electrons and (ii) an oxidizing agent that undergoes reduction through the gain of electrons. Conversion-type rechargeable batteries transfer electrons from one material to another via an electric circuit. One conversion-type rechargeable battery is a metal-sulfur battery where the metal acts as the anode and the sulfur acts as the cathode.

As used herein, the terms “shuttling” and “redox shuttle” refers to an effect in metal-sulfur batteries caused by the dissolution of active polysulfide intermediates in an organic liquid electrolyte and the diffusion back and forth of the polysulfide between the metal anode and the sulfur cathode. Shuttling can cause poor cycling stability and severe anode corrosion.

As used herein, the term “oxidizing gas” refers to a gas that induces a redox reaction in a rechargeable battery. Examples of oxidizing gases include, without limitation, molecular oxygen (O₂), clean dry air (21% O₂, 79% N₂), nitric oxide (NO), nitrogen dioxide (NO₂), and combinations thereof. Within the context of the present invention, an oxidizing gas that is used to enhance the metal-sulfur batteries disclosed herein may include one or more inert gases.

As used herein, the term “inert gas” refers to a noble gas in Group 18 of the period table. Examples of Group 18 noble gases include, without limitation, helium (He), neon (Ne), argon (Ar), krypton (Kr), xenon (Xe), and radon (Rn).

As used herein, the term “cathode” refers to the positive electrode of a battery cell that receives electrons from an external circuit and is reduced during discharging, and transfers electrons to an external circuit through oxidation during charging. Within the context of metal-sulfur batteries, the elemental sulfur of the cathode dissolves into a liquid electrolyte in the form of long-chain polysulfides that serve as a liquid catholyte (electrolyte adjacent to the cathode). The dissolution of the polysulfides in the liquid electrolyte facilitates the electrochemical reactions of the sulfur (which is an insulating species), but also causes dissolution of the polysulfides resulting in redox shuttle and parasitic shuttling reactions with the metal anode.

As used herein, the term “anode” refers to the negative electrode of a battery cell that transfers electrons to an external circuit through oxidation during discharging and receives electrons from an external circuit and is reduced during charging. During the discharge process of a metal-sulfur battery, metal ions are stripped from the anode and ionized at which time the resulting electron becomes available to the external load current. The metal ions migrate through the electrolyte to the cathode where they combine with the sulfur at the cathode. Due to shuttling, the amount of sulfur available at the cathode becomes progressively less resulting in less sulfur-rich metal polysulfides engaging in the redox reaction between the cathode and the anode.

As used herein, the term “metal halide” refers to a compound having a metal and a halogen. The metals of metal halides may be any metal in Groups 1 to 16 of the periodic chart but will typically be Group 1 alkali metals or Group 2 alkali earth metals. Examples of Group 1 alkali metals include, without limitation, lithium (Li), sodium (S), potassium (K), rubidium (Rb), cesium (Cs), and francium (Fr). Examples of Group 2 alkali earth metals include, without limitation, beryllium (Be), magnesium (Mg), calcium (Ca), strontium (Sr), barium (Ba), and radium (Ra). The halides of the metal halides will be any halogen in Group 17 of the periodic chart, which include, without limitation, fluorine (F), chlorine (Cl), bromine (Br), and iodine (T).

As used herein, the term “diatomic halogen” refers to a pair of halogen atoms chemically joined together. Examples of diatomic halogens include, without limitation, diatomic fluorine (F₂), diatomic chlorine (Cl₂), diatomic bromine (Br₂), and diatomic iodine (I₂).

As used herein, the term “hybrid” is used to refer to a cathode that comprises a mixture of two or more different active cathode materials and a battery that incorporates a cathode comprising a mixture of two or more different active cathode materials. For example, a hybrid cathode may comprise a mixture of a metal halide and sulfur (e.g., a lithium iodide-sulfur or LiI—S cathode) or a mixture of a halogen and sulfur (e.g., a sulfur-iodine or I₂—S cathode). A battery comprising a hybrid metal halide-sulfur cathode may be referred to herein as a hybrid metal halide-sulfur battery (e.g., a lithium-iodide-sulfur or LiI—S battery when the battery anode is a lithium metal) and a battery comprising a hybrid sulfur-halogen cathode may be referred to herein as a hybrid sulfur-halogen battery (e.g., a lithium-iodine-sulfur or Li—I₂—S battery when the battery anode is a lithium metal).

As used herein, the term “electrolyte” refers to a material that provides for ion transport between the anode and cathode of a battery cell. An electrolyte acts as a medium for ion transport through its interaction with the anode and the cathode. Upon battery charging, an electrolyte facilitates the movement of ions from the cathode to the anode, whereas upon discharge, the electrolyte facilitates the movement of ions from the anode to the cathode. In rechargeable batteries, the electrolyte promotes ion cycling between the anode and the cathode. Electrolytes may be solid or liquid. Where the electrolyte is a liquid, it generally has three components, a solvent, an ionic conductor (e.g., an ionic salt), and additives.

As used herein, the term “ionic salt” refers to a salt that when dissolved in a solvent completely or partially breaks into ions. Within the context of the present invention, the combination of the salt and the solvent conducts the ions.

As used herein, the term “SEI” refers to a “solid electrolyte interphase” layer. Starting from the first cycle of battery operation, an electrolyte starts to decompose and in so doing leaves compounds on the electrode surfaces, which form an SEI layer. For example, within the context of a traditional lithium-containing batteries, the electrolyte will decompose to form lithium compounds, which in turn form the SEI layer. Since the SEI layer contains numerous lithium compounds, the production of the SEI tends to reduce the total charge capacity of the battery by consuming some of the lithium that would otherwise be used to store charge resulting in a battery with low Coulombic efficiency and low discharge capacity. The enhanced metal-sulfur battery described herein overcomes the shortcomings associated with the formation of SET layers on electrode surfaces.

As used herein, the term “battery operation” refers to any charging and/or discharging that occurs after battery assembly. Within the context of the metal halide-sulfur hybrid cathode described herein, at the time of battery assembly, the active sulfur cathode material is in a charged state and the active metal halide cathode material is in a discharged state resulting in a battery with an intermediate state of charge (SOC). In order to bring the hybrid cathode into a state of 100% SOC, a “pre-charging” current is applied to the assembled battery cell; thus, the term “pre-charging” as used herein falls within the scope of “battery operation.”

As used herein, the term “prior to battery operation” refers to any condition before a battery undergoes any charging and/or discharging. Within the context of the present invention, oxygen (O₂) enhancement can be applied “prior to battery operation.”

Described herein is an enhanced conversion-type rechargeable battery comprising an anode, a cathode containing a sulfur or a sulfur-halide composite, and an oxidizing gas. The rechargeable battery exhibits improved capacity (˜75% increase) over Li-ion batteries currently in use and a prolonged cyclic life with high Coulombic efficiency (>95%). The battery demonstrates high power density, fast-charging capability in an oxygen environment, and overcomes the deficiencies of the Li-ion and metal-sulfur batteries currently in use. Deficiencies of L-ion batteries include poor theoretical capacity normalized by cathode weight in comparison to metal-sulfur batteries. Deficiencies of metal-sulfur batteries include poor cycling efficiency due to shuttling. Thus, while L-ion batteries show high stability, they have low capacity and while metal-sulfur batteries show high capacity, they have low stability and limited cycle life due to capacity loss. The enhanced metal-sulfur batteries described herein overcome the redox shuttle inherent in traditional metal-sulfur batteries and prevents the reaction of dissolved polysulfides with the anode.

The metal-sulfur batteries described herein may be enhanced with an oxidizing gas, a metal halide, a diatomic halogen, and combinations thereof.

In one embodiment of the enhanced metal-sulfur battery, the anode is a metal selected from the group consisting of lithium (Li), magnesium (Mg), zinc (Zn), aluminum (Al), sodium (Na), and combinations thereof.

In another embodiment, the cathode comprises sulfur incorporated into an electrically conductive material. In a further embodiment, the cathode comprises sulfur and a metal halide incorporated into an electrically conductive material, wherein the sulfur and the metal halide are co-active cathode materials. In another embodiment, the metal halide is lithium iodide (LiI) and the rechargeable metal-sulfur battery is a hybrid lithium-iodide-sulfur (LiI—S) battery. In a further embodiment, the cathode comprises sulfur and a diatomic halogen incorporated into an electrically conductive material, wherein the sulfur and the diatomic halogen are co-active cathode materials. In another embodiment, the diatomic halogen is selected from the group consisting of F₂, Cl₂, Br₂, I₂, and combinations thereof. In a further embodiment, the diatomic halogen is diatomic iodine (I₂). In another embodiment, the electrically conductive material comprises a carbon-based material. In a further embodiment, the carbon-based material is porous. In another embodiment, the electrically conductive carbon-based material is selected from the group consisting of carbon black, carbon nanotubes, carbon nanofibers, activated carbon, amorphous carbon, graphite, graphene, and combinations thereof.

In a further embodiment, the electrolyte comprises a solvent with at least one organic liquid and at least one ionic salt. Examples solvents comprising organic liquids include, without limitation, 1,3-dioxolane (DOL), 1,2-dimethoxymethane (DIME), tetrahydrofuran (THF), and combinations thereof. Examples of ionic salts include, without limitation, lithium bis(trifluoromethanesulfonyl)imide (LiTFSI), lithium nitrate (LiNO₃), and combinations thereof. In another embodiment, the electrolyte is in ionic contact with the anode and the cathode. In a further embodiment, the electrolyte is in physical contact with the anode and the cathode.

In another embodiment, the oxidizing gas is selected from the group consisting of molecular oxygen, clean dry air, nitric oxide, nitrogen dioxide, and combinations thereof. Within the context of the present invention, the oxidizing gas works in concert with the electrolyte to form a stable SEI (solid-electrolyte interphase) layer on the surface of the electrodes thus promoting the redox reaction of the active cathode materials. In another embodiment, the oxidizing gas is dissolved in the solvent prior to battery operation. In another embodiment, the oxidizing gas is dissolved in the solvent during battery operation. In another embodiment, the oxidizing gas comprises molecular oxygen (O₂) wherein the molecular oxygen has a volume % that is 20-100% of the total volume of the oxidizing gas and any additional inert gas or gases present in the oxidizing gas. In a further embodiment, the inert gas is selected from the group consisting of He, Ne, Ar, Kr, Xe, Rn, and combinations thereof.

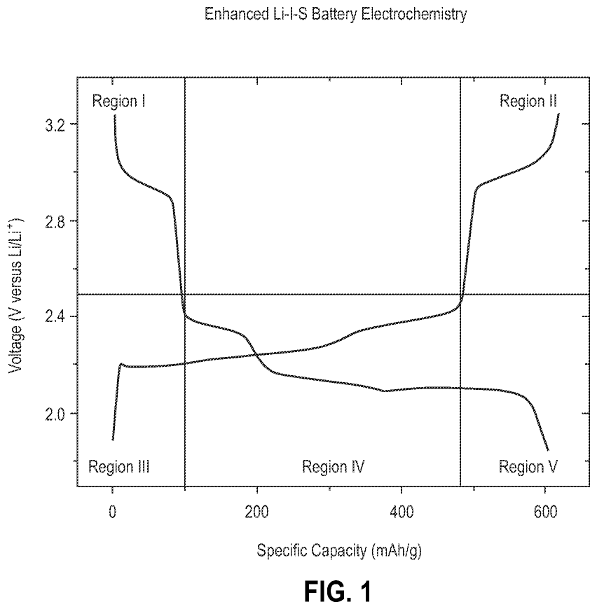

FIG. 1 is a graph of the charge/discharge curves for a LiI—S battery enhanced by the presence of O₂ gas during the first charge/discharge cycle of battery operation (following any pre-charging and/or formation) (Example 2). The vertical and horizontal guidelines divide the curves into five regions and distinguish between active capacity charged or discharged from the metal halide of the cathode (lithium iodide, LiI) in Regions I and II and the sulfur of the cathode in Regions III-V. The specific capacity in FIG. 1 is normalized by the combined weight of both the sulfur and LiI active cathode materials.

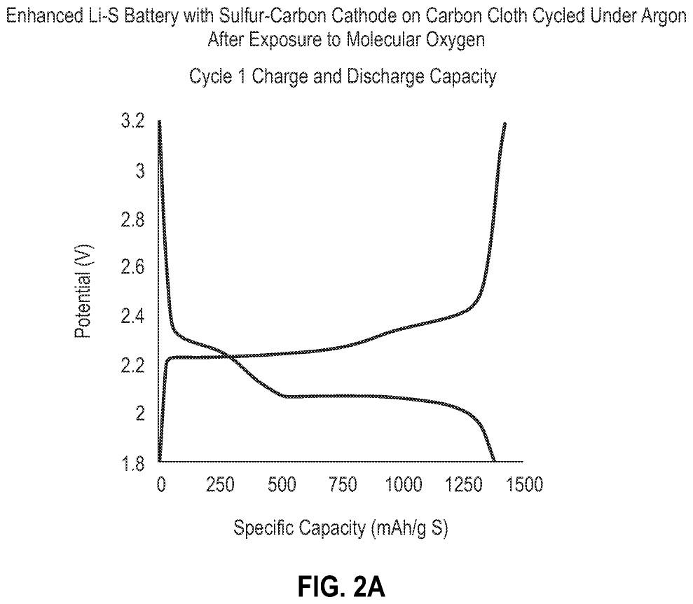

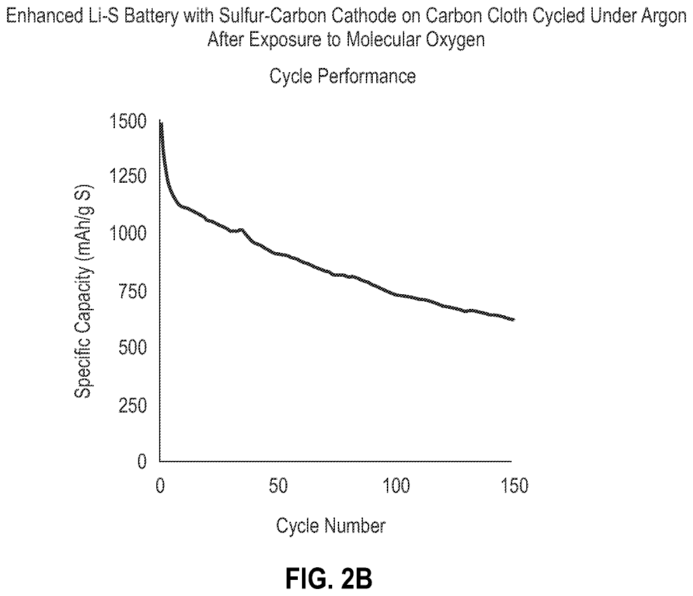

FIGS. 2A and 2B show the performance of a metal-sulfur battery with a lithium anode and a sulfur-containing carbon cathode prepared on porous carbon cloth and cycled under argon after exposure to an oxidizing gas (molecular oxygen, O₂) prior to cycling (Example 3). FIG. 2A shows the first charge/discharge curves of battery operation and FIG. 2B shows the cycle performance of the battery. The “S” in the specific capacity units indicate that the specific capacity is normalized by the active material only (sulfur in this case) and not be the total cathode weight, which includes non-active components.

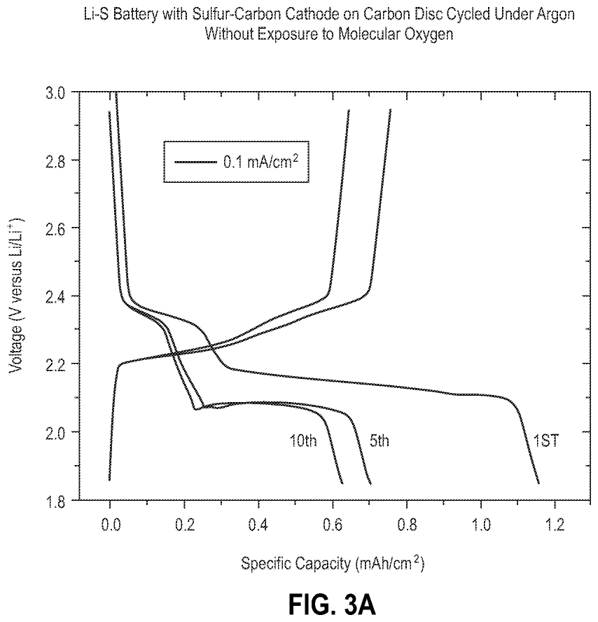

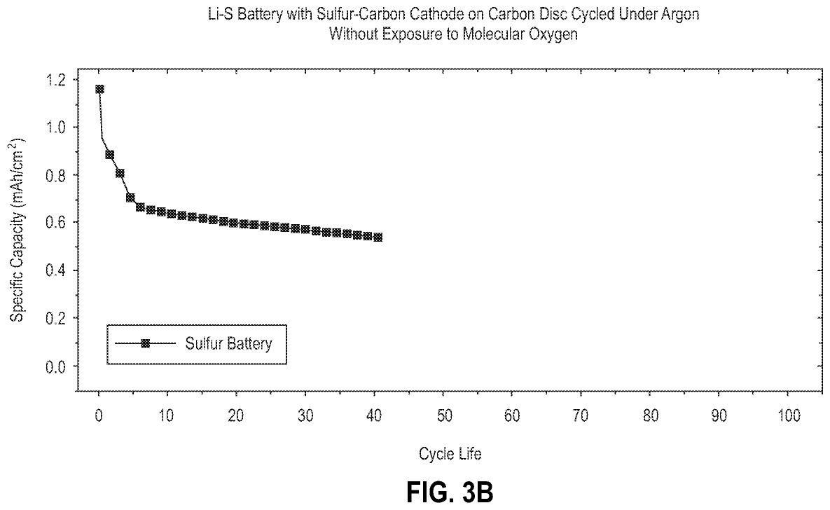

FIGS. 3A and 3B show the performance of a metal-sulfur battery with a lithium anode and a sulfur-containing carbon cathode cycled under argon without exposure to an oxidizing gas prior to cycling (Comparative Example 1). FIG. 3A shows two charge curves and three discharge curves (1st, 5th, and 10th) for the battery and FIG. 3B shows the cycle performance of the battery over 40 cycles. Consistent with what is known regarding the high capacity and low stability of Li—S batteries, the data show that the Li—S battery is able to achieve an initial charging capacity of close to 1.2 mAh/cm² (FIG. 3A), but after less than three cycles, the battery is at 80% of its original capacity (FIG. 3B).

The data in FIGS. 2A, 2B, 3A and 3B show that by operating a metal-sulfur battery in the presence of an oxidizing gas, the first cycle specific capacity of the battery cell increases by >75% from 785 mAh/g to 1375 mAh/g (FIG. 2A). Even after 150 cycles, the specific capacity of the cathode is at 600 mAh/g (FIG. 2B).

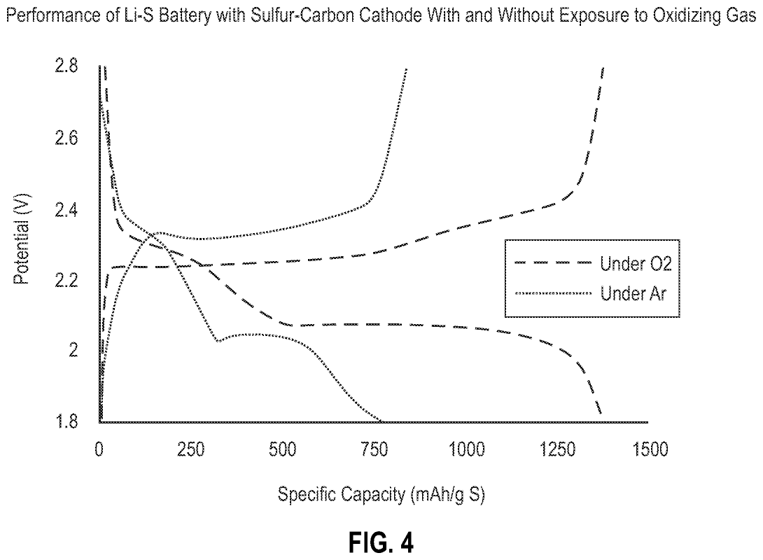

FIG. 4 provides an overlay of the first charge and 5th discharge curve of the Li—S battery of Comparative Example 1 (dotted line—from FIG. 3A) against the first charge/discharge curve of the Li—S battery of Example 3 (dashed line—from FIG. 2A). A comparison of FIGS. 2-4 shows that the presence of an oxidizing gas significantly reduces the cycle-to-cycle capacity loss that is characteristic of metal-sulfur batteries, reducing the capacity loss of the first 40 cycles from 75% to 35% and stabilizing the cycling at 700-800 mAh/g specific capacity. Even after 150 cycles, the battery with the sulfur cathode treated with the oxidizing gas maintained a specific capacity above 600 mAh/g (FIG. 2B). By contrast, in the battery with the sulfur cathode that was not treated with an oxidizing gas, the specific capacity dropped below 600 mAh/g after less than 10 cycles (FIG. 3B).

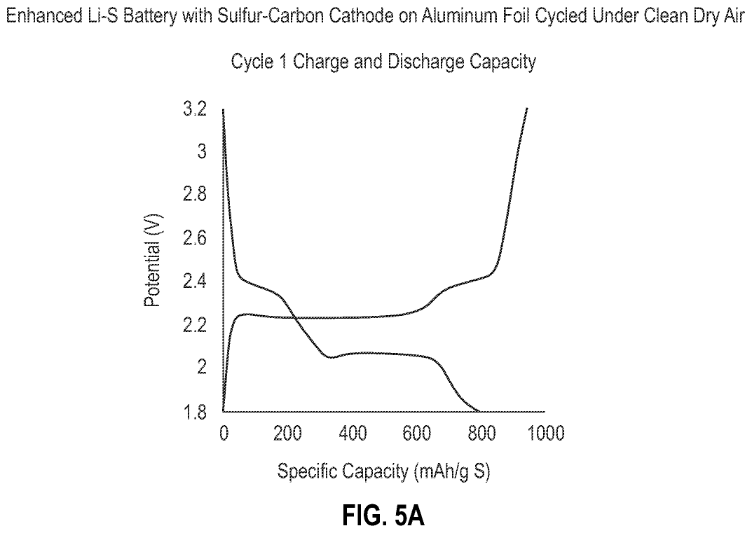

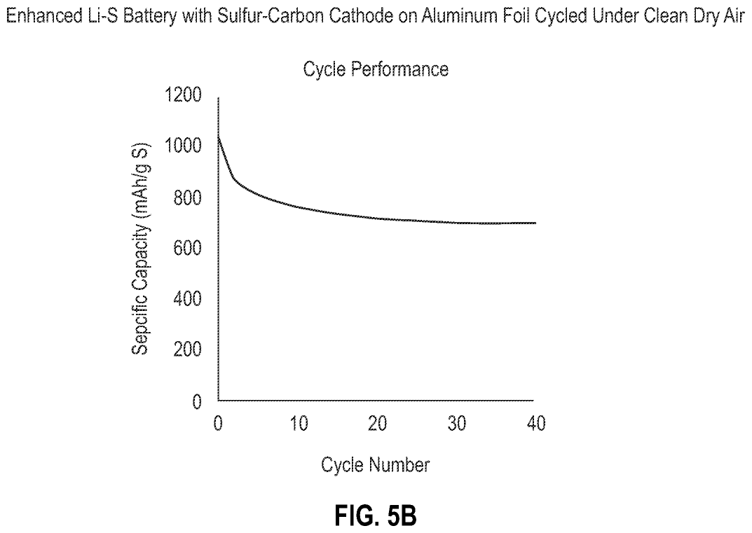

FIGS. 5A and 5B show the performance of a battery with a lithium anode and a sulfur-containing carbon cathode prepared on an aluminum foil current collector cycled under an oxidizing gas of clean dry air in which the vol % (or partial pressure) of oxygen in the oxidizing gas is 21% (Example 4). FIG. 5A shows the first charge/discharge curves of battery operation for the cathode and FIG. 5B shows the cycle performance of the cathode over 40 cycles, supporting that an oxidizing gas with only 21 vol % (or partial pressure) molecular oxygen (and where the oxidizing gas contains additional gases) can still improve performance of a lithium-sulfur battery. While the air enhancement results in good stability (FIG. 5B), the aluminum current collector produces a battery with reduced capacity (FIG. 5A) in comparison to the enhanced L-S battery prepared on a carbon current collector (FIG. 2A). The “S” in the specific capacity units indicates that the specific capacity is normalized by the active material only (sulfur in this case) and not by the total cathode weight, which includes non-active components.

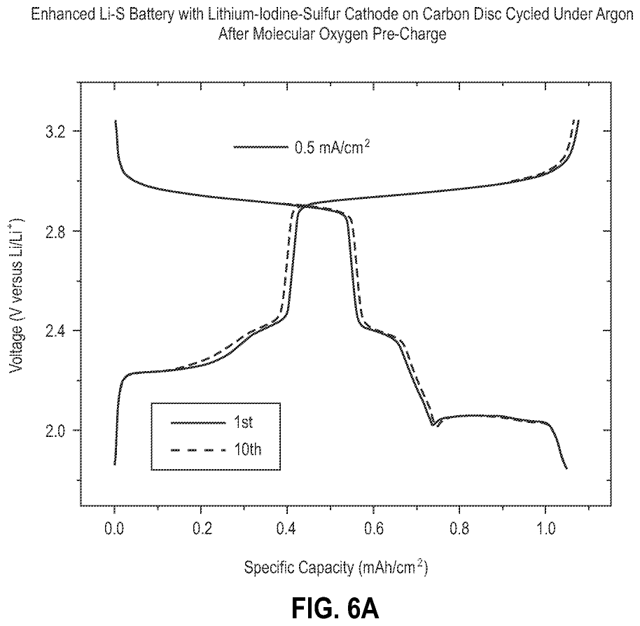

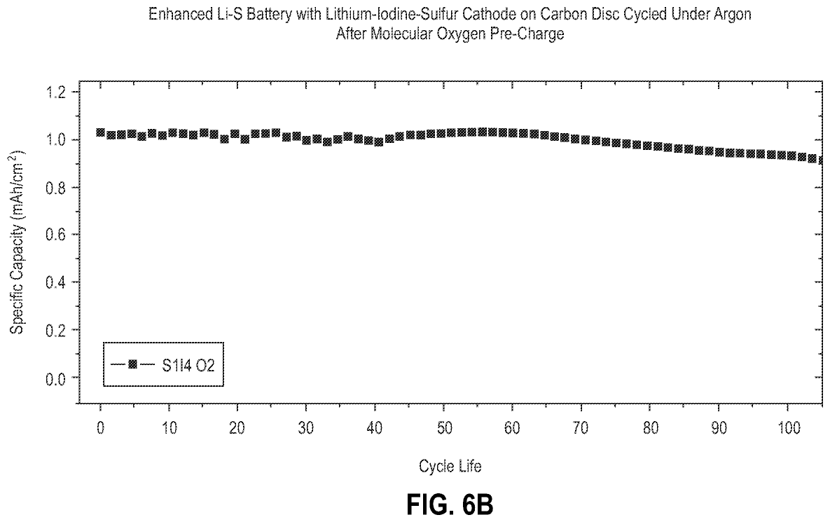

FIGS. 6A and 6B show the performance of a metal-sulfur battery with a lithium anode and a hybrid LiI—S cathode prepared on a carbon disc and cycled under argon after pre-charging under an oxygen environment (Example 5). FIG. 6A shows the charge/discharge curves for the first and tenth cycles and FIG. 6B shows the cycle performance of the battery over more than 100 cycles. The hybrid LiI—S cathode results in a high capacity and stable battery that (i) has the same capacity after ten cycles as it has after the first cycle (FIG. 6A) and (ii) achieves more than 100 cycles at 80% of its original capacity (FIG. 6B). The results in FIGS. 6A and 6B show that an oxidizing gas does not need to be supplied for the full operation cycles of a battery; rather, exposing a battery to an oxidizing gas at pre-charging is sufficient for improving battery performance.

The improvement in the stability of batteries comprising the enhanced sulfur-containing cathodes described herein is surprising and unexpected given the current understanding of the mechanism underlying the capacity loss in L-S batteries. With Li—S batteries, the presence of oxidizing species is known to impair the long-term function of batteries cells that include an electrolyte with sulfur dioxide (SO₂) due to the reaction of the oxidizing species with the SO₂. In contrast to what is known in the art, with the enhanced metal-sulfur batteries described herein, the presence of the oxidizing gas enhances the stability and capacity of the battery. Surprisingly and unexpectedly, the oxygen, alone or in combination with the presence of a diatomic halogen or metal halide in the sulfur-containing cathode, facilitates the formation of a unique SEI layer on the anode that prevents shuttling, acts as a redox mediator, and does not solvate the conducting salt. The foregoing effects result in a mechanistically distinct metal-sulfur battery with increased cell stability and improved energy density over prior art metal-sulfur batteries. The oxygen-induced SEI layer is also a scalable and cost-effective way to produce a passivation layer on an anode thus avoiding the need for expensive passivation materials, such as strontium.

The descriptions of the various aspects and/or embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the aspects and/or embodiments, the practical application or technical improvement over technologies found in the marketplace, or to enable others of ordinary skill in the art to understand the aspects and/or embodiments disclosed herein.

### EXPERIMENTAL

The following examples are set forth to provide those of ordinary skill in the art with a complete disclosure of how to make and use the aspects and embodiments of the invention as set forth herein. While efforts have been made to ensure accuracy with respect to variables such as amounts, temperature, etc., experimental error and deviations should be considered. Unless indicated otherwise, parts are parts by weight, temperature is degrees centigrade, and pressure is at or near atmospheric. All components were obtained commercially unless otherwise indicated.

### Example 1

### General Procedure for Cell Fabrication

1,3-dioxolane (DOL), 1,2-dimethoxyethane (DME), lithium nitrate (LiNO₃), lithium iodide (LiI), N-methyl-2-pyrrolidone (NMP), and sulfur were purchased from Sigma-Aldrich (Millipore Sigma, Burlington, MA, USA). Lithium bis(trifluoromethanesulfonyl)imide (LiTFSI), and polyvinylidene fluoride (PVDF) were provided as a sample by Solvay, S.A. (Neder-Over-Hemmbeek, Brussels, BE). The LiNO₃, UiTFSI, and LiI were dried at 160° C. under an inert argon environment and stored in an argon filled glovebox (<0.1 ppm H₂O, O₂). The cathodes were prepared in one of two ways.
Method 1. A hybrid lithium iodide-sulfur (LiI—S) cathode was prepared by incorporating LiI and elemental sulfur onto a carbon coated disc.
Method 2. A sulfur-carbon (S—C) composite material was prepared by heating sulfur and carbon particles in a glass vial and heating to at least 160° C. for at least 24 hrs. The S—C composite was then suspended in a solution of PVDF in NMP. The slurry solution was cast onto a conductive substrate and dried at 160° C. for at least 12 hrs.

The following procedure was applied to both cathodes as prepared: A CELGARD® 2325 separator (Celgard, LLC, Charlotte, NC, USA) was placed between the lithium metal anode and the composite cathode. An electrolyte solution comprising LiTFSI, DOL, DME, and LNO₃ was used to wet the separator. All cell assembly was done in an argon filled glovebox or a dry box full of clean, dry air. All cell components were placed within a SWAGELOK®-type cell (Swagelok Corp., Solon, OH, USA) equipped with both inlet and outlet tubing for gas flow or a 2032-coin cell device and sealed under an atmosphere of either argon or clean, dry air (21% O₂, 79% N₂). In the case of the SWAGELOK-type device, the cell was completely sealed by closing the valves of both the inlet and the outlet tubing. Oxygen was incorporated into the cell by either: (1) infusion of pure O₂ during a pre-cycle rest period; (2) infusion of pure O₂ during the first charging cycle; or (3) sealing the cell under an atmosphere of clean, dry air (21% O₂/79% N₂).

### Example 2

### O₂ Enhanced Hybrid Lithium-Iodide-Sulfur (LiI—S) Battery

A rechargeable metal-sulfur battery was fabricated with a cathode of 20-70-10 S—C-PVDF on a carbon cloth current collector and a lithium anode. The S—C-PVDF cathode was further modified by the application of ethanolic LiI until the ratio of S to LiI was approximately 4:1. The battery was operated at a current density of 1 mA/cm². The cell was pre-charged under pure O₂ prior to cycling. After completion of the first charge/discharge cycle, the cell was purged with Ar gas and cycled normally. FIG. 1 shows the charge/discharge curves from the first cycle of battery operation under Ar gas. With reference to the Regions shown in FIG. 1, capacity from the LiI/I₂ redox couple was observed in Regions I and II, and capacity from the Li₂S/S redox couple was observed in Regions III, IV, and V.

### Example 3

### O₂ Enhanced Lithium-Sulfur (Li—S) Battery with Carbon-Sulfur Cathode on Carbon Cloth

A rechargeable metal-sulfur battery was fabricated with a cathode of 20-70-10 S—C-PVDF on a porous carbon cloth current collector and a lithium anode. The battery was operated at a current density of 1 mA/cm². The battery was allowed to rest at open-circuit voltage (OCV) for 15 minutes under an O₂ environment at 0.5 bar above the atmosphere (1.5 atm positive pressure of O₂ gas). Following the OCV, the battery was immediately purged with inert Ar gas for 15 sec with an intention to completely replace the O₂ gas. The battery was operated under Ar for the remaining cycles at room temperature. The performance of the battery is shown in FIG. 2A (first cycle charge/discharge curves) and FIG. 2B (cycling performance for 150 cycles).

### Comparative Example 1

### Rechargeable Lithium-Sulfur (Li—S) Battery Tested Under Argon without Exposure to O₂

A rechargeable metal-sulfur battery was fabricated with a sulfur cathode prepared on a carbon disc and a lithium anode. The battery was operated under inert Ar gas at room temperature at a current density of 0.1 mA/cm². The performance of the battery is shown in FIG. 3A (charge/discharge curves for the first, fifth, and tenth cycles) and FIG. 3B (cycling performance for over 40 cycles).

### Example 4

### Rechargeable Lithium-Sulfur (Li—S) Battery with a Carbon-Sulfur Cathode on Aluminium Foil Cycled Under Clean Dry Air

A rechargeable metal-sulfur battery was fabricated with a cathode of 20-70-10 S—C-PVDF on an aluminum foil current collector and a lithium anode. The battery was operated at a current density of 2 mA/cm². A coin cell type battery was assembled inside a dry-box full of clean dry air (21% oxygen). The performance of the battery is shown in FIG. 5A (first cycle charge/discharge curves) and FIG. 5B (cycling performance for 40 cycles).

### Example 5

### Rechargeable Hybrid Lithium-Iodide-Sulfur (LiI—S) Battery Cycle Life Performance after Pre-Charging Under O₂

A rechargeable hybrid metal halide-sulfur battery was fabricated with a cathode of LiI and sulfur in a 4:1 wt. % and a lithium anode. The battery was operated at a current density of 0.5 mA/cm². To increase the state of charge (SOC) to 100%, the battery was pre-charged one time under oxygen environment at 0.5 bar above the atmosphere (1.5 atm positive pressure of O₂ gas). After pre-charging, the battery was immediately purged with inert argon for 5 min with an intention to completely replace the oxygen gas. The battery was operated under argon for the remaining cycles of battery operation at room temperature. The performance of the battery is shown in FIG. 6A (charge/discharge curves for the 1st and 10th cycles of battery operation) and FIG. 6B (cycling performance for over 100 cycles).

We claim:

1. A battery, comprising:
an anode;
a cathode comprising sulfur, wherein the cathode is incorporated into an electrically conductive material; and
an electrolyte in contact with the anode and the cathode, the electrolyte comprising (i) a solvent with at least one organic liquid compound and (ii) at least one ionic salt dissolved in the solvent, wherein an oxidizing gas is dissolved in the solvent prior to and/or during battery operation.

2. The battery of claim 1, wherein the cathode further comprises a diatomic halogen and/or a metal halide.

3. The battery of claim 2, wherein the halogen of the diatomic halogen and the halide of the metal halide is selected from the group consisting of I, Br, Cl, and F.

4. The battery of claim 1, wherein the anode is a metal selected from the group consisting of Li, Mg, Zn, Al, Na, and combinations thereof.

5. The battery of claim 1, wherein the cathode is a hybrid sulfur-iodine cathode or a hybrid lithium iodide-sulfur cathode.

6. The battery of claim 1, wherein the electrically conductive material comprises a carbon-based material selected from the group consisting of carbon black, carbon nanotubes, carbon nanofibers, activated carbon, amorphous carbon, graphite, graphene, and combinations thereof.

7. The battery of claim 1, wherein the oxidizing gas is selected from the group consisting of oxygen, air, nitric oxide, nitrogen dioxide, and combinations thereof.

8. The battery of claim 1, wherein the oxidizing gas comprises a molecular oxygen, wherein the molecular gas has a volume % that is 20-100% of the total volume of the oxidizing gas and any additional inert gas or gases present in the oxidizing gas.

9. A battery comprising:
an anode;
a cathode comprising sulfur, wherein the cathode is incorporated into an electrically conductive material;
an oxidizing gas comprising molecular oxygen; and
an electrolyte comprising a solvent and at least one ionic salt, wherein the electrolyte is in contact with the anode, the cathode, and the oxidizing gas.

10. The battery of claim 9, wherein the cathode further comprises a diatomic halogen and/or a metal halide.

11. The battery of claim 10, wherein the halogen of the diatomic halogen and the halide of the metal halide is selected from the group consisting of I, Br, Cl, and F.

12. The battery of claim 9, wherein the anode is a metal selected from the group consisting of Li, Mg, Zn, Al, Na, and combinations thereof.

13. The battery of claim 9, wherein the cathode is a hybrid sulfur-halogen cathode or a hybrid metal halide-sulfur cathode.

14. The battery of claim 9, wherein the molecular oxygen has a volume % that is 20-100% of the total volume of the oxidizing gas and any additional inert gas or gases present in the oxidizing gas.

15. The battery of claim 9, wherein the electrically conductive material comprises a carbon-based material.

16. The battery of claim 15, wherein the carbon-based material is selected from the group consisting of carbon black, carbon nanotubes, carbon nanofibers, activated carbon, amorphous carbon, graphite, graphene, and combinations thereof.

17. The battery of claim 9, wherein the oxidizing gas is dissolved in the solvent prior to and/or during battery operation.

18. A battery, comprising:
an anode comprising a metal selected from the group consisting of Li, Mg, Zn, Al, Na, and combinations thereof;
a cathode comprising iodine and sulfur, wherein the cathode is incorporated into a carbon-based material;
an oxidizing gas comprising molecular oxygen, wherein the molecular oxygen has a volume percentage that is 20-100% of the total volume of the oxidizing gas and any additional inert gas or gases present in the oxidizing gas; and
an electrolyte comprising a solvent and at least one ionic salt, wherein the electrolyte is in contact with the anode, the cathode, and the oxidizing gas.

19. The battery of claim 18, wherein the oxidizing gas is dissolved in the solvent prior to and/or during battery operation.

20. The battery of claim 18, wherein the iodine is selected from lithium iodide (LiI) and diatomic iodine (I₂).
